(19) United States
(12) Patent Application Publication
(10) Pub. No.: US 2003/0075099 A1
(43) Pub. Date: Apr. 24, 2003

(54) Publication highlighting and marking system and method

(76) Inventors: Kurt W. Dowdle, Sandy, UT (US); Franklin M. Young, Taylorsville, UT (US)

Correspondence Address: TRASK BRITT, P.O. BOX 2550, SALT LAKE CITY, UT, 84110, US

(21) Appl. No.: 10/046,375

(22) Filed: Oct. 22, 2001

(51) Int. Cl. B42D 9/00

(52) U.S. Cl. 116/235

(57) ABSTRACT

A publication highlighting implement and method for making the same. The implement includes a plurality of film segments which are transparent upon application to a publication containing textual material. A graphic is printed on each segment for highlighting the textual material which the graphic is placed over. The graphic may be printed in fluorescent ink so as to increase the visibility and noticeability of the segment thus drawing attention to the underlying textual material. Additionally, the graphic may be printed to simulate a three-dimensional image or object causing the marked section to further stand out. The plurality of film segments may be arranged on a sheet of backing which is configured for use as a bookmark which may further contain advertising material thereon. Each segment may include a scalloped edge for increased ease of removal from the original backing as well as from the publication to which it is adhered.

### BACKGROUND OF THE INVENTION

1. Field of the Invention

The present invention relates generally to marking and highlighting text in a publication. More specifically, the present invention relates to a system and method of marking and highlighting text and/or graphics of a publication without impairing legibility of the same and while allowing removal of such highlighting in a non-destructive manner.

2. State of the Art

Marking and highlighting text in publications, such as for example, text books, periodicals, or religious texts, is widely practiced. Such marking and highlighting typically involves the use of colored markers, such as pens, pencils, felt type markers, or wax based markers, to underscore or overlay the text or graphics causing the highlighted portion of a particular page stand out. By highlighting a particular section of a publication the reader thereof may more effectively refer back to the highlighted text or graphic for refreshing, quick review, or occasional reference without the need to laboriously search through the pages of text in an effort to find the desired information.

The use of such highlighters and markers in academic, professional, and personal study can be quite extensive, and often results in individuals utilizing multiple colors of highlighters to organize their studies by category of information. As an example, a medical student or practitioner might highlight or mark a text containing information on specific diseases or ailments for future reference. In doing so, the individual might mark or highlight symptoms of the disease in a first color, effects of the disease in a second color, and possible treatments of the disease in a third an separate color. Thus, the user of the publication may customize the information according to his or her own liking and preference for organization. Of course, this type of technique or method of marking is often utilized in other topics or areas of study as well.

Such practices are common because of their aid in efficiently learning and recalling information during the study and practice of various academic disciplines. As noted before, the practice of highlighting text is also common among those conducting personal studies such as the study of religious texts. However, while the practice of highlighting and marking publications is widely known and utilized, the current state of the art suffers from various drawbacks and inconveniences.

One such drawback is that many current markers and highlighters, such as those described above, are typically used to deposit ink onto a page of the publication. The use of ink creates a permanent mark in the publication which may not be removed or relocated once it has been applied to the publication. Additionally, the use of ink often causes “bleeding” to the opposite side of the page, particularly when the page is made from a light or fine grade of paper. Likewise, the ink may be inadvertently transferred to a facing page once the publication is closed, or possibly smear to adjacent sections of text not previously highlighted. Smearing and bleeding not only leave unwanted permanent marks in the publication, but also lead to inefficiencies since various passages of the publication appear to have been marked when, in fact, the passage which was actually marked occurs elsewhere such as on the back side of the page, or possibly on a facing page. Such problems are not limited to ink based markers or highlighters. Wax based markers may similarly smear or transfer to a facing page.

Another concern regarding the marking and highlighting techniques mentioned above is that the act of marking or highlighting a passage is one of permanence. Thus, when a student marks a passage in his or her text book, that section remains marked and may not be subsequently changed. This poses several problems. First, students often wish to sell their text books back to the school bookstore at the end of a semester or course. Often, numerous markings and highlighted sections in a book will reduce the buy-back value of the publication. Second, it often occurs that the first time a publication is read a particular passage or section of information will be highlighted. However, the next time the publication is utilized, it may be determined that the originally highlighted section is not as important as originally thought. Alternatively, it may be that, upon the first reading, too much material contained in the publication was highlighted. Having too much or incorrect information highlighted reduces the efficiency of marking a publication and serves to negate the original intentions of doing so.

Another problem associated with the permanence of current marking and highlighting techniques involves research wherein the publications being studied and searched through are not owned by the reader or researcher. Thus, for example, numerous publications may be compiled with each publication containing specific information important to the research at hand. However, because the publications may have been borrowed, such as from a library, the user will refrain from marking the pertinent information in the publications knowing that such marking and highlighting will deface the material and may detract from subsequent reading or research of the material by another. Thus, such research is often lacking in efficiency due to a reader's inability to mark selected portions of the publication for subsequent reference.

Additionally, traditional marking implements such as ink based highlighters are generally retained separately from publications, allowing for the inconvenience of misplacing the same. It is often the case, as one goes from studying in a first environment, such as a home, to studying in a second environment, such as the library, that the highlighter is misplaced or forgotten since it is not always retained with the publications. While some attempts have be made to make a highlighter which may be retained with a given publication (for example, see U.S. Pat. No. 5,984,558 issued to Diep), it is unlikely that an individual would desire to retain such a marker with each and every publication which is being studied and marked. Also, such a device as taught by Diep fails to address the issues of permanence and inadvertent marking described above.

Other attempts have been made to address some of the various issues associated with highlight publications. Some of these attempts have even tried to address the issue of permanent marking and highlighting of publications. However, the attempted solutions have no been without difficulties and drawbacks of their own. For example, one such proposed marking system is disclosed in U.S. Pat. No. 5,409,753 issued to Perez. This system includes a plurality of removable adhesive dots which are placed over a paragraph or verse number in a publication, specifically a bible, adjacent the text of the paragraph or verse. The adhesive dots are retained on a separate card as a part of a kit which is attached to the back of the publication. However, as is well understood by users of such devices, it is often difficult to remove adhesive stickers from their respective backing, which potentially makes the use of such adhesive dots difficult for certain individuals. Additionally, such a system as described by Perez is particularly adapted for use in marking scriptures as is indicated by the disclosure. While attaching a dedicated marking kit to the back, or inside the back cover, of an individual publication which serves as the basis of long term dedicated study serves a purpose, attaching an individual kit to each of a plurality of publications or texts would become a burden to the user and make such publications cumbersome.

Another highlighting medium is described in U.S. Pat. No. 4,913,946 issued to Sala et al. The highlighter of the Sala patent is described as a fluorescent adhesive tape for application to, and subsequent removal from, a publication. However, Sala describes this highlighter in terms of a roll of a continuous roll of tape from which segments may be removed for highlighting one or more passages of a publication. However, a roll of tape is subject to misplacement just as described above with regard to ink type markers and other similar highlighters. Additionally, carrying a roll of highlighting tape would likely prove more inconvenient than carrying an individual ink or writing type highlighter since a roll of tape having a sufficient quantity thereof is likely to be larger and bulkier. This is especially true since a roll of tape is likely to require an accompanying dispenser which inherently adds to the overall size of the highlighting implement.

Additionally, the state of the art could be improved with regard to its ability to direct one's attention to specifically marked passages. With increased use of graphics, bold print, and multi color printing implemented in current publications, it becomes necessary to more clearly differentiate a specifically identified or highlighted item of information in a publication from the text and graphics of the publication itself.

In view of the shortcomings in the state of the art, it would be advantageous to provide a highlighter and highlighting system which is easily removable and which doesn't damage a publication while allowing for unimpaired reading of original text when applied thereto. Additionally, it would be advantageous to provide a highlighter which allows for greater differentiation between the printed page and the specific material selected and marked by an individual. Such a highlighter and system would preferably be simple to use and capable of being easily retained with a publication to avoid loss or misplacement.

### BRIEF SUMMARY OF THE INVENTION

In accordance with one aspect of the invention a publication highlighting implement is provided. The implement includes at least one segment of film having a first surface and a second opposing surface. Adhesive is applied to the first surface of the film segment. The at least one segment is removably adhered to a backing member by means of the adhesive. At least one of the first or second surfaces includes a printed graphic on at least a portion thereof. The film segment is defined by a periphery or a perimeter which includes a scalloped edge along at least a portion of the perimeter, the scalloped edge facilitating easier removal of the segment from the backing as well as from a publication to which it may be applied.

The backing member may be configured for use as a bookmark and may further include a graphic printed thereon comprising, for example, an advertisement of a local bookstore or other retailer.

Desirably, the highlighting implement includes a plurality of segments formed and adhered to the backing member. The printed graphics of each segment are configured to overlay printed or textual material and mark or highlight such material without visible degradation of the printed material to a reader thereof viewing the printed material through the segment.

In accordance with another aspect of the invention, a publication highlighting implement is provided having at least one transparent film segment with first and second opposing surfaces. Adhesive is applied to the first surface of the film segment and a printed graphic is located on at least a portion of the second surface of the film segment. The printed graphic is configured to have a three-dimensional appearance or simulate a three-dimensional object such that it draws a viewer's attention more efficiently to the area of text upon which it is placed upon. The three-dimensional appearing image is formed by varying the ink composition of the graphic in specific areas to render an image of “highlights” and “shadows” thus giving the illusion of depth to the image.

In accordance with yet another aspect of the invention, a method of manufacturing a publication highlighting implement is provided. The method includes providing a sheet of clear stock film and placing adhesive on a first side of the polyester film. The film is removably adhered to a sheet of backing. The sheet of clear stock film is segregated into a plurality of a segments. In segregating the film into individual segments, a scalloped, sinusoidal or otherwise undulating edge is formed along a portion of each segment. A graphic is also printed on a portion of each segment, the graphic being configured to overlay printed material to mark or highlight it without degrading the readability of the material.

### BRIEF DESCRIPTION OF THE SEVERAL VIEWS OF THE DRAWINGS

The foregoing and other advantages of the invention will become apparent upon reading the following detailed description and upon reference to the drawings in which:

FIGS. 1A and 1B depict a publication highlighting implement according to one embodiment of the invention;

FIGS. 2A and 2B depict alternative embodiments of particular aspects of the highlighting implement shown in FIGS. 1A and 1B;

FIG. 3 is a perspective view of a publication with which the highlighting implement of FIGS. 1A and 1B is utilized;

FIG. 4 is an elevational view of a plurality of highlighting implements in a package according to one embodiment of the invention; and

FIG. 5 depicts an alternative embodiment of a particular aspect of the highlighting implement of FIGS. 1A and 1B.

### DETAILED DESCRIPTION OF THE INVENTION

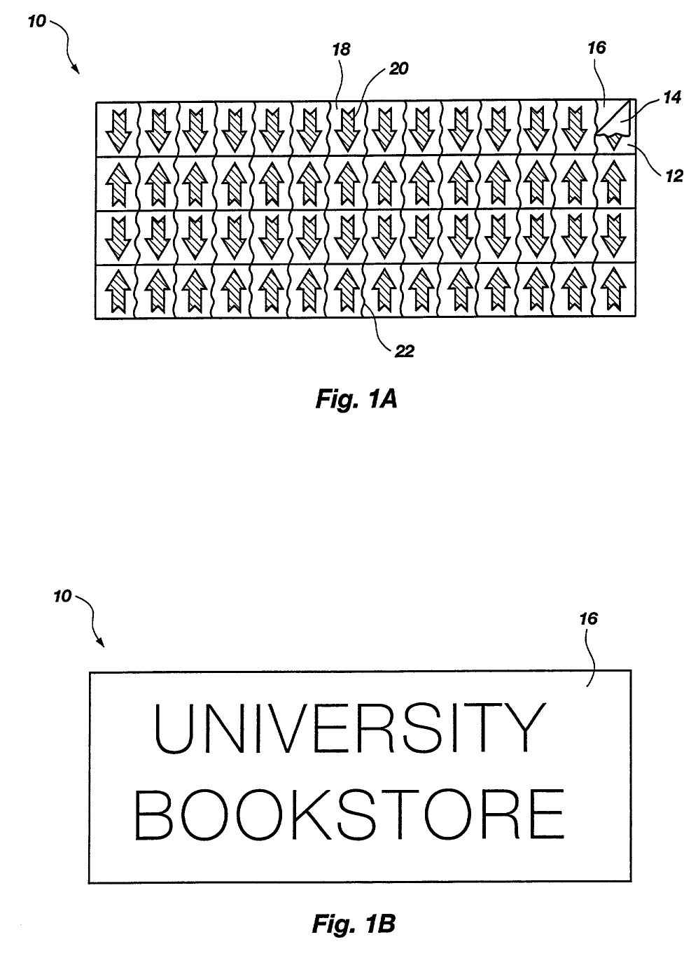

Referring to FIGS. 1A and 1B, a publication highlighting implement 10 is shown. It is noted that the term “publication,” as used herein, is meant to include any leaf or page having text or graphics thereon. The highlighting implement 10 includes a transparent layer 12 formed of a clear stock film material. Such clear stock material may include, for example, polyester, acetate or MYLAR. While numerous materials may be suitable, polyester has proved to provide durability and a resistance to tearing.

The transparent layer 12 is relatively thin and desirably has a thickness in the range of 1.0 to 3.0 thousandths of an inch (0.001 to 0.003 in). Adhesive is placed on the back surface 14 of the transparent layer 12 allowing the transparent layer 12 to be removably adhered to a sheet of flexible backing 16. Alternatively, the adhesive may be placed on the sheet of backing 16 for removable adherence of the transparent layer 12. An exemplary backing material which may be used includes Flex-O-Backer available from MACtac, located at 4560 Darrow Road, Stow, Ohio 44224.

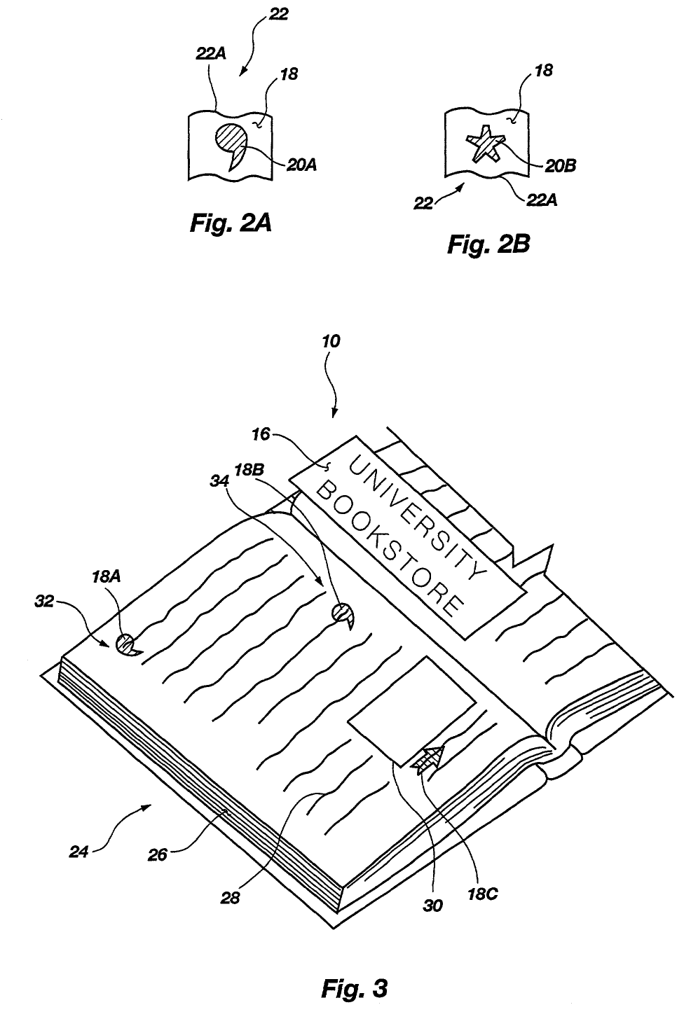

The transparent layer 12 is cut or segregated into a plurality of individual segments 18 with each segment being individually removable from the sheet of backing 16. Each segment 18 includes a printed graphic 20 on a surface thereof. The printed graphic 20 is designed to differentiate an identified passage of text or other information within the publication and thus allow a viewer to easily find and recall the identified information. The graphic 20 may include an arrow, as shown in FIG. 1A, or may include other graphical symbols such as, for example, a quote mark 20A as seen in FIG. 2A, or an asterisk 20B as seen in FIG. 2B. Of course other symbols may likewise be utilized and the examples utilized herein should not be viewed as limiting of the invention in any way.

The graphic 20 may be printed as one or more of various colors with bright colors being more preferable for their quality of quickly attracting the attention of a viewer. Thus, for example yellow, red, green, orange, and other bright colors, and particularly fluorescent variants of such bright colors, help to effectively and efficiently mark and differentiate selected text or information in a publication. The graphic 20 may be printed on either side of the transparent film 12, or alternatively, the graphic 20 may be printed on both sides of the transparent film 12. Printing on both sides of the film may allow for added contrast or for a more intense appearance of the graphic. However, if the graphic 20, or a portion thereof is printed on the back side 14 of the transparent film 12, it should be printed or otherwise formed prior to placing adhesive thereon.

The graphic 20 is additionally printed in a manner such that each segment 18 maintains its transparent qualities and may be placed over text or other printed matter without visible degradation of the printed matter. Thus, it is important that each graphic 20 not only be “see through,” but also be “read through” so as to not impair a viewer's ability to read or decipher the information being marked or highlighted by the particular graphic 20.

As can be seen in FIG. 1A, as well as FIGS. 2A and 2B, each segment 18 includes a scalloped, or “crinkle-cut” edge 22. The scalloped edge 22 is formed as a curved edge including an undulating-type pattern along one or more edges of the segment 18. The scalloped edge 22 assists in removal from both the sheet of backing 16 as well as subsequent removal from a printed publication. When an individual desires to remove a segment 18 from the backing 16 or from a printed publication, they will typically use their fingernail to lift the segment 18 by an edge 22, and particularly a corner thereof. By forming a scalloped edge 22 there are more extended protrusion points provided along the edge 22 with each protrusion being an effectual “corner” for lifting the segment 18 off of the backing 16 or a publication page. Alternatively, or in addition to lifting the segment by a “corner,” an individual may attempt removal of the segment 18 by slightly bending the backing 16 or publication page to cause an edge 22 of the segment 18 to “lift” therefrom. Oftentimes, the edge 22 of segment 18 will lift easier if one initiates the bend at an angle with respect to the specific edge 22 to be lifted. The scalloped edge 22 effectively provides an edge having a continuously varied angle making it easier to lift the segment 18 from the backing 16 or printed publication regardless of the angle at which one initiates a bend. The scalloped edge 22 may be formed such that numerous protrusions 22A are formed along a defined edge of a single segment 18, but desirably includes at least one fully developed protrusion 22A formed along at least one edge of each individual segment 18.

The backing 16 is configured in size and shape such that it may be utilized as a bookmark. Thus, the highlighting implement 10 may be stored with a publication such that it will not be misplaced. Additionally, an individual highlighting implement 10 may be fabricated so as to be relatively inexpensive in comparison with an ink based marker or highlighter thus allowing an individual to easily obtain multiple highlighting implements 10 and retaining one or more with each of a plurality of publications being studied.

Referring to FIG. 1B, the reverse side of the backing 16, opposite the plurality of segments 18, may include a university logo, bookstore name or trademark, or some other institutional advertisement. The structure of the highlighting implement lends itself to a certain level of customization such that any retailer stocking and selling such a highlighting implement 10 may have a customized institutional advertisement printed on the highlighting implement 10, thus making it more desirable for the retailer to sell such an item.

Alternatively, the reverse side of the backing 16 may include decorative graphics, outline helps, such as, for example, a periodic table, or other printed matter that makes the highlighting implement more desirable to a retailer and/or a consumer.

Referring to FIG. 3, use of the highlighting implement 10 in conjunction with a publication 24 is shown. The publication 24 includes a plurality of pages 26 each having text 28, publication graphics 30, or other printed information thereon. The highlighting implement 10 may be used as a bookmark for quick identification of a specific page 26, or may alternatively be inconspicuously placed elsewhere in the publication for retention. Individual segments 18 are removed from the backing 16 of the highlighting implement 10 and placed over sections of text 28 or printed material identified by the reader of the publication 24. For example the beginning 32 of an identified passage may be marked with a first segment 18A and the ending 34 of the same passage may be identified with a second segment 18B. The graphical symbols associated with segments 18A and 18B are shown as single quotes which serves to more readily identify the marked text as a complete passage or a single concept. However, other graphics could be utilized in similar manner. Additional segments 18 could be placed within the identified passage for heightened emphasis is so desired. Alternatively, an individual segment 18 may be used to indicate identified material such as is shown with respect to segment 18C highlighting information adjacent the publication graphic.

It is noted that the segments 18A-18C are placed over printed material of the publication 24, such as the printed text 28. The segment 18 calls attention to the marked text due to its color and graphic printed thereon. However, the text 28 is readable through all portions of the segment 18 including the printed graphic. It is also noted, that the edges (scalloped or otherwise) are not shown in FIG. 3. This is indicative of the present invention being formed of a thin transparent film 12 which allows the segments 18 to be placed on printed matter with only the graphic 20 being substantially differentiable from the printed matter itself. Thus the edges of the segment 18, as well as any portion of the segment not having a graphic or other matter printed thereon is essentially undetected, furthering the ability of the inventive highlighting segments 18 to call attention to specific information without any extraneous structure which may be unsightly or detracting.

However, it is noted that the present invention may alternatively include a thin transparent film 12 which allows a slight amount of perceived differentiation between the segment 18 and the publication 24. Such would allow a user to more easily locate one or more edges, including the scalloped edge 22, for subsequent removal of the segment from the publication 24.

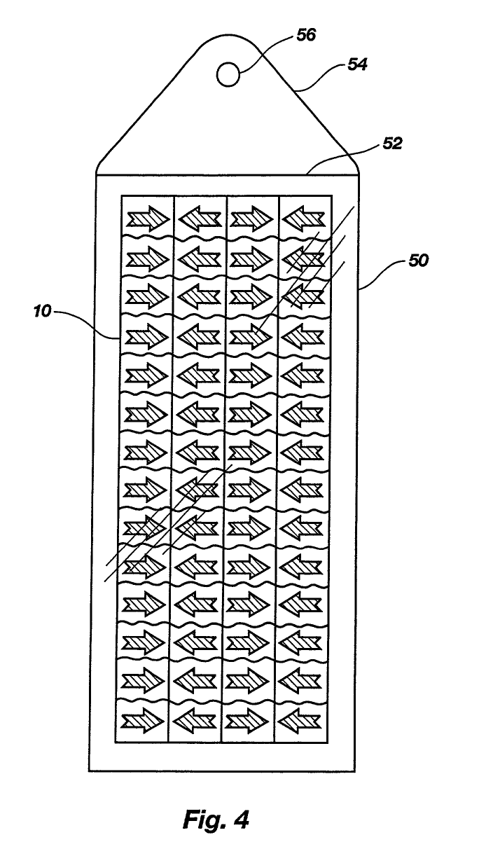

Referring briefly to FIG. 4, a plurality of highlighting implements 10 is shown in exemplary packaging 50 as may be utilized for containing the highlighting implements 10 during transport and display by a retailer, as well as for storing the highlighting implements 10 when not in use. The packaging 50 may be formed as a sleeve with an opening 52 at one end for insertion and removal of the highlighting implements 10. The packaging 50 may additionally be formed of a clear plastic material such that the highlighting implements 10 are viewable while contained therein.

The packaging may further include a tab 54 which is foldable and insertable into the opening 52. The tab 54 thus serves to close the packaging such that the highlighting implements 10 are securely contained within the packaging 52. Additionally, an aperture 56 may be formed in the tab 54 for hanging or otherwise displaying the packaging 50 and highlighting implements 10 in a retail establishment. The packaging 50 may contain a sufficient number of highlighting implements 10, for example 5 or 10, while still maintaining a thin profile such that the packaging 50 and plurality of highlighting implements 10 may be stored in a publication without causing the publication to become unduly bulky.

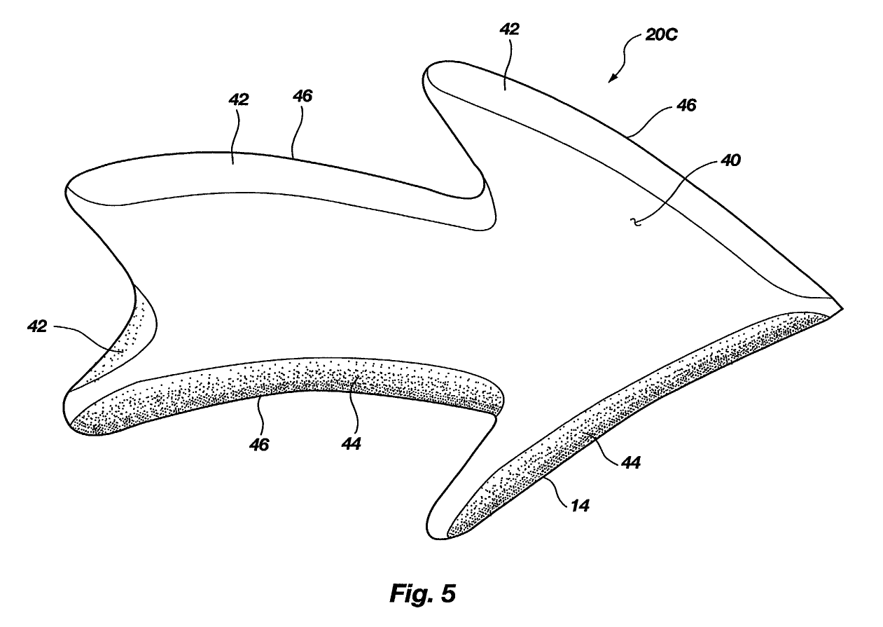

Referring now to FIG. 5, an alternate graphic 20C is shown which may be incorporated with the highlighting implement 10 disclosed herein. The graphic 20C is shown as an arrow, but, as apparent to those of ordinary skill in the art, the various aspects of the disclosed graphic 20C are applicable to other symbols as well. The graphic 20C may be discussed as having multiple zones or regions. A first zone 40 is generally centrally located and is of a specified color having a first level of intensity in appearance. A first set of multiple regions 42 are located generally along the upper and trailing edge of the graphic 20C and exhibit an appearance of the same general color as that of region 40, but having an apparent change in intensity such that it appears that light is shining more directly thereon. A second set of multiple regions 44 is located generally along the bottom and leading edges of the graphic 20C exhibiting an appearance of a darkened or shadowed section having little or no light shining thereon. The specific graphic 20C shown thus creates a three-dimensional appearing image by creating the illusion of a light source placed above the graphic 20C and creating highlights and shadows, indicating that the image has a certain depth or thickness.

The three-dimensional appearing graphic 20C is formed through a printing process devoid of black ink. Use of black ink would impair the readability of any text the graphic 20C might overlay. Thus, for example, in producing the three-dimensional appearing graphic, and particularly such a graphic having a fluorescent appearance, the graphic 20C may be printed with a predetermined combination of red, blue and yellow fluorescent inks. The proper combination (i.e. a predetermined ratio) of these inks in a first composition would produce the colored central area of the graphic 20C. Another combination of the same inks, in a second composition would render a “blackened” or darkened appearance for the shadowed regions 44 and yet another combination of the same inks in a third composition would render a proper color for lightened regions 42 to render the three-dimensional appearance of the graphic. Each of the different ink compositions are formulated so as to not impede the readability of any underlying text to which a segment 18 might be adhered.

Two dimensional graphics 20 may also be printed by combining red, blue and yellow fluorescent inks in a predetermined ratio to render a desired color with desired visual qualities. It is noted that conventional printing processes utilize a combination of cyan, magenta, yellow and black (c/m/y/k) to render a desired color. The use of red, blue and yellow with an absence of black is a departure from conventional printing processes. The printing process utilized described herein renders a bright and viewable image on a transparent film which allows application of the image to printed text without visual degradation of the text to a reader.

It is further noted that the graphic 20C shown in FIG. 5 includes a plurality of curved edges 46 which combine to render a graphic which is without a perceived orientation. The portrayal of the graphic 20C without a perceived orientation may provide a certain efficiency in that users of the highlighting implement 10 will not be distracted by trying to “align” the segment 18 and corresponding graphic 20C with any particular portion of publication, such as, for example, a line of text contained therein.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A publication highlighting implement comprising:
at least one segment of film having a first surface and a second opposing surface;
adhesive applied to the first surface of the at least one film segment;
a backing member to which the first surface of the at least one film segment is removably adhered;
a printed graphic on at least a portion of at least one of the first and second surfaces of the at least one film segment; and
an undulating edge along at least a portion of a perimeter of the at least one film segment.

2. The implement of claim 1, wherein the printed graphic is configured to overlay textual material without visual degradation of the textual material to a viewer thereof.

3. The implement of claim 2, wherein the graphic covers only a portion of the at least one film segment and wherein a portion of the film segment without a printed graphic becomes substantially transparent upon application of the film segment to the publication.

4. The implement of claim 1, wherein the segment of film comprises an polyester film.

5. The implement of claim 4, wherein the segment of film has a thickness of approximately 1.5 to 2 thousandths of an inch (0.0015 to 0.002 in).

6. The implement of claim 1, wherein the printed graphic exhibits a fluorescent appearance.

7. The implement of claim 1, wherein the printed graphic simulates a three-dimensional image.

8. The implement of claim 1, wherein the backing is configured as a bookmark.

9. The implement of claim 1, further comprising an advertisement placed on a portion of the bookmark.

10. The implement of claim 1, wherein the at least one film segment includes a plurality of film segments.

11. The implement of claim 10, wherein at least a first and a second film segment are adjacently positioned on the backing member with at least a portion of the undulating edge of the first film segment is cooperatively contiguous with at least a portion of the undulating edge of the second film segment.

12. The implement of claim 10, wherein the plurality of film segments are positioned on the backing member in an array of rows and columns.

13. The implement of claim 12, wherein at least a portion of the undulating edge of each film segment is cooperatively contiguous with at least a portion of the undulating edge of an adjacent film segment.

14. The implement of claim 10, wherein a first film segment and a second film second are configured to be placed cooperatively to indicate the beginning point and ending point of a section of textual material in a publication, the textual material encompassing an area of the publication larger than the first and second film segments.

15. A publication highlighting implement comprising:
at least one transparent film segment having a first surface and a second opposing surface;
adhesive applied to the first surface of the at least one film segment;
a backing member to which the first side of the at least one film segment is removably adhered;
a printed graphic on a portion of at least one of the first and second surfaces of the at least one film segment, the graphic having a three-dimensional appearance.

16. The implement of claim 15 wherein the printed graphic exhibits a fluorescent appearance.

17. A publication highlighting implement comprising:
at least one segment of polyester film having a first surface and a second opposing surface, the film having a thickness of approximately 1.0 to 3.0 thousandths of an inch (0.001 to 0.003 in);
adhesive applied to the first surface of the at least one polyester film segment;
a backing member to which the first side of the at least one film segment is removably adhered, the backing member comprising a bookmark having an institutional advertisement thereon;
a fluorescent appearing graphic simulating a three-dimensional object printed on a portion of at least one of the first and second surfaces of the at least one polyester film segment, the three-dimensional appearing graphic being printed with a predetermined combination of ink consisting of red, blue and yellow fluorescent ink; and
an undulating edge along at least a portion of a perimeter of the at least one polyester film segment.

18. A method of manufacturing a publication highlighting implement comprising:
providing a sheet of polyester film;
placing adhesive on a first side of the sheet of polyester film;
removably adhering the first side of the sheet of polyester film to a sheet of backing;
segregating the sheet of polyester film into a plurality of segments;
forming at least one undulated edge on each segment; and
printing at least one graphic on a portion of each segment.

19. The method of claim 18, wherein printing a graphic on a portion of each segment includes printing a fluorescent graphic.

20. The method of claim 19, wherein printing a fluorescent graphic includes printing with predetermined a combination of red, blue and yellow fluorescent ink.

21. The method of claim 20, wherein printing a graphic on a portion of each segment includes printing a graphic simulating a three-dimensional object.

22. The method of claim 21, further comprising configuring the sheet of backing as a bookmark.

23. The method of claim 22, further comprising printing an institutional advertisement on the bookmark.

24. The method of claim 18, wherein printing a graphic on a portion of each segment includes printing a three-dimensional appearing graphic.

25. The method of claim 24, wherein printing a graphic on a portion of each segment further includes printing a fluorescent graphic.

26. The method of claim 25, wherein printing a fluorescent graphic includes printing the graphic with an ink consisting of a predetermined combination of red, blue and yellow fluorescent ink and exclusive of black ink.
